(19) United States
(12) Patent Application Publication
(10) Pub. No.: US 2006/0064852 A1
(43) Pub. Date: Mar. 30, 2006

(54) Strap handle

(75) Inventor: Roger P. Willems, High Wycombe (GB)

Correspondence Address: Robert D. Hornbaker;Freilich Hornbaker & Rosen, Suite 1220, 10960 Wilshire Boulevard, Los Angeles, CA, 90024, US

(73) Assignee: Penn Elcom, Inc.

(21) Appl. No.: 10/949,593

(22) Filed: Sep. 24, 2004

(51) Int. Cl. H01M 2/10

(52) U.S. Cl. 16/444

(57) ABSTRACT

A handle comprising a substantially flat strap 2, with an elongated opening, or slot 3, 4, in each end, and a grip member 5 attached to the middle part of the strap 2.

### BACKGROUND OF THE INVENTION

Prior Art handles for carrying a box may be formed of a flat strap having an elongated opening, or slot, in each end, a grip member, with a channel therein, surrounding the middle part of the strap, and fasteners extending through the elongated openings, or slots, in each end, and into, or through, the box, for fastening the ends to the box. But the straps in these handles are not attached to the grip member, which causes noise, if the box contains a vibrating object, such as loudspeaker.

### SUMMARY OF THE INVENTION

The present invention eliminates the noise by attaching the grip member to the strap.

It is therefore an object of the invention to eliminate the noise in a handle for a box having a flat strap and a grip member with a channel therein surrounding the middle part of the strap.

Another object of the invention is to provide a minimum number of parts for fastening the ends of the handle to the box.

A still further object of the invention is to make an aesthetically pleasing handle.

### BRIEF DESCRIPTION OF THE DRAWINGS

FIG. 1 is a perspective view of the assembled handle.

FIG. 2 is a cross-section view taken along line 2-2 of FIG. 1.

FIG. 3 is a bottom view of the assembled handle.

FIG. 4 is a cross-section view taken along line 4-4 of FIG. 3, with the handle flat on a box.

FIG. 5 is a cross-section view taken along line 4-4 of FIG. 3, with the middle part of the handle curved away from the box.

FIG. 6 is an exploded isometric view of the handle showing all of the parts.

### DESCRIPTION OF THE PREFERRED EMBODIMENT

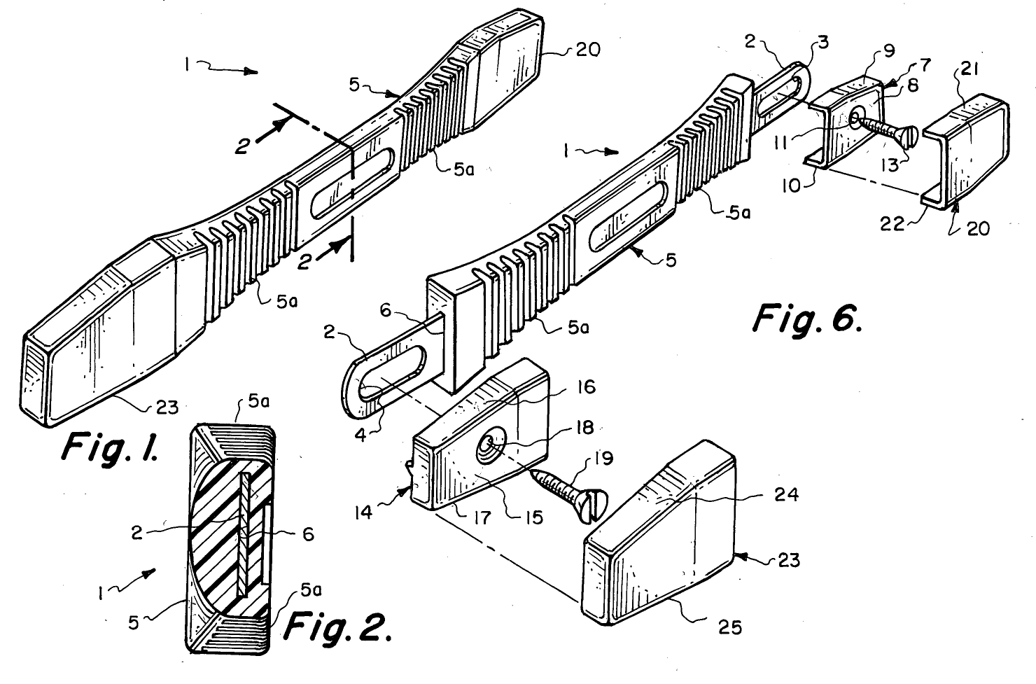

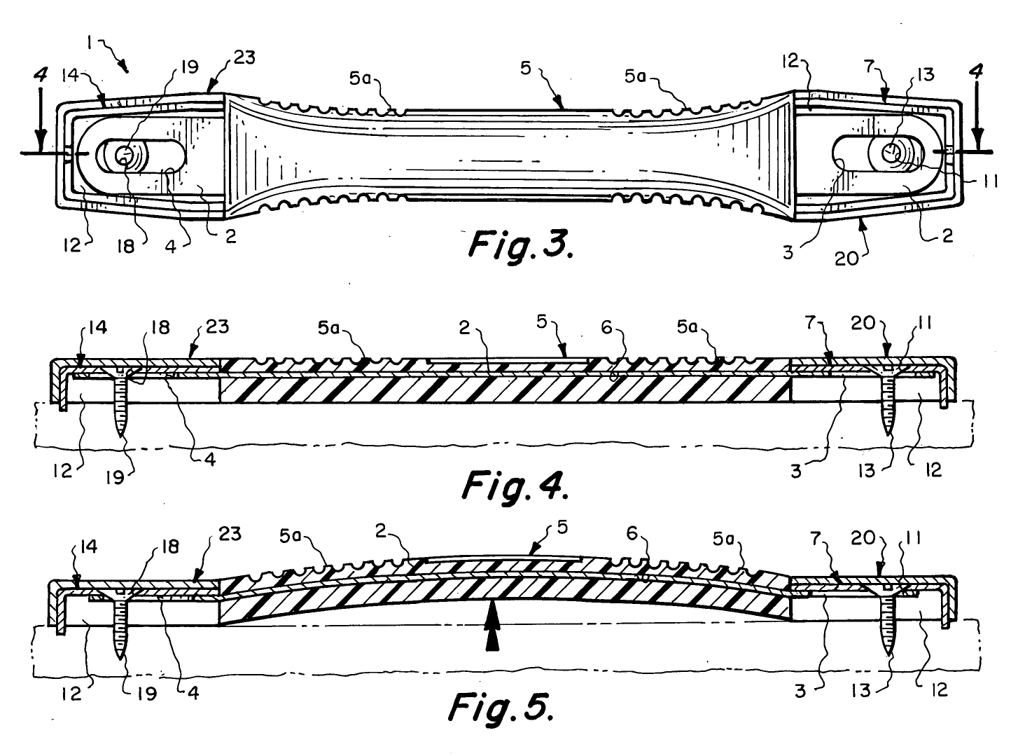

Referring to FIGS. 1, 2 and 4-6, the handle 1 comprises a substantially flat strap 2, with a first elongated opening, or slot 3, in one end, a second elongated opening, or slot 4, in the other end, and a grip member 5 with a channel 6 therein, surrounding the strap 2, and attached thereto. As best shown in FIG. 2, the grip member 5 is rounded on the side next to the box to fit the inside curvature of a gripping hand. The grip member 5 with a channel 6 therein, surrounding the strap 6, may be attached thereto, by an adhesive, or by heating a heat-shrinkable grip member, but the preferred way is by injection molding, that is, the middle part of a metal strap, such as spring steel, is placed in a mold, and a plastic, or rubber, is injected into the mold, and allowed to harden, after which the strap and adhering plastic, or rubber, is removed from the mold. As best shown in FIGS. 1 and 4-6, the top part of the grip member 5 is molded with grooves 5a, to make it aesthetically pleasing.

The words “attached to” and “attached thereto,” as used herein, includes “formed together in a mold with,” “caused to adhere to, or thereto,” and “forming a unitary structure with.” The word “metal,” as used herein, includes “any of a class of chemical elements, such as iron, aluminum, etc., generally characterized by ductility, malleability, luster and conductivity of heat and electricity, and alloys including at least one of said elements, such as steel.” In addition, the word “plastic,” as used herein, includes “any of various nonmetallic compounds, synthetically produced, usually from organic compounds by polymerization, which can be molded into various forms and hardened, or formed into pliable sheets or films for commercial use.” Finally, the word “rubber,” as used herein, includes “an elastic substance produced by coagulating and drying the milky sap of various tropical plants, or produced synthetically or by chemically altering latex to obtain desired characteristics.”

As best shown in FIG. 6, the handle includes a first end piece 7 having a top 8, a pair of depending sides 9, 10, and an opening 11 in the top 8. The end piece is located on the box 12, over one end of the strap 2, with the end of the strap 2 between the depending sides 9, 10, with the opening 11 in the first end piece 7 aligned with the first elongated opening, or slot 3, in the strap 2. A first fastener, such as screw 13, extends through the opening 11 in the first end piece 7, the first elongated opening, or slot 3, in the strap 2, and into the box 12.

Likewise, as best shown in FIG. 6, the handle 2 includes a second end piece 14 having a top 15, a pair of depending sides 16, 17, and an opening 18 in the top 15. The second end piece 14 is located on the box 12, over the other end of the strap 2, with the end of the strap 2 between the depending sides 16, 17, with the opening 18 in the second end piece 14 aligned with the second elongated opening, or slot 4, in the strap 2. A second fastener, such as screw 19, extends through the opening 18 in the second end piece 14, the second elongated opening, or slot 4, in the strap 2, and into the box 12. Obviously, a threaded bolt, extending through the box 12, with a nut on the end, can be used instead of a screw. So the word “fastener,” as used herein, includes screws and bolts. As shown in FIGS. 4 and 5, the screws 13, 18 in the box 12, are located remote from the ends of the elongated openings, or slots 3, 4, so that the screws 13, 18, will contact the ends of the elongated openings, or slots 3, 4, when the middle part of the handle is curved away from the box, for lifting.

A first cap 20, having a pair of depending sides 20, 21, is located over the first end piece 7, with the depending sides 20, 21 of the first cap 20 engaging the depending sides 9, 10 of the first end piece 7, to cover the head of the screw 13, to make an aesthetically pleasing handle.

Likewise, a second cap 23, having a pair of depending sides 24, 25, is located over the second end piece 14, with the depending sides 24, 25 of the second cap 23 engaging the depending sides 1, 17 of the second end piece 14, to cover the head of the screw 19, to make an aesthetically pleasing handle.

While I have shown and described the preferred embodiments of my invention, unsubstantial changes may be made therein. So I do not intend to be limited by the preferred embodiments, and intend that the following claims, and equivalents, shall describe the limits of my invention.

1. A handle comprising:
a substantially flat strap, with an elongated opening, or slot, in each end; and
a grip member attached to the middle part of the strap.

2. A handle as described in claim 1 in which the strap is metal.

3. A handle as described in claim 1 in which the grip member is plastic or rubber.

4. A handle as described in claim 1 in which the strap is metal and the grip member is plastic or rubber.

5. A box and handle comprising:
a box;
a substantially flat strap, with an elongated opening, or slot, in each end;
a grip member attached to the middle part of the strap;
a first end piece having a top, a pair of depending sides, and an opening in the top, the first end piece being located on the box, over one end of the strap, with the end of the strap between the depending sides, and the opening in the first end piece aligned with the first elongated opening, or slot, in the strap;
a first fastener extending through the opening in the first end piece, the first elongated opening, or slot, in the strap, and into, or through, the box;
a second end piece having a top, a pair of depending sides, and an opening in the top, the second end piece being located on the box, over the other end of the strap, with the end of the strap between the depending sides, and the opening in the second end piece aligned with the second elongated opening, or slot, in the strap; and
a second fastener extending through the opening in the second end piece, the second elongated opening, or slot, in the strap, and into, or through, the box.

6. A box and handle as described in claim 5 in which the strap is metal.

7. A box and handle as described in claim 5 in which the grip member is plastic or rubber.

8. A box and handle as described in claim 5 in which the strap is metal and the grip member is plastic or rubber.

9. A box and handle comprising:
a box;
a substantially flat strap, with an elongated opening, or slot, in each end;
a grip member attached to the middle part of the strap;
a first end piece having a top, a pair of depending sides, and an opening in the top, the first end piece being located on the box, over one end of the strap, with the end of the strap between the depending sides, and the opening in the first end piece aligned with the first elongated opening, or slot, in the strap;
a first fastener extending through the opening in the first end piece, the first elongated opening, or slot, in the strap, and into, or through, the box;
a second end piece having a top, a pair of depending sides, and an opening in the top, the second end piece being located on the box, over the other end of the strap, with the end of the strap between the depending sides, and the opening in the second end piece aligned with the second elongated opening, or slot, in the strap; and
a second fastener extending through the opening in the second end piece, the second elongated opening, or slot, in the strap, and into, or through, the box.
a first cap, having a pair of depending sides, located over the first end piece, with the depending sides of the first cap engaging the depending sides of the first end piece;
a second cap having a pair of depending sides, located over the second end piece, with the depending sides of the second cap engaging the depending sides of the second end piece.

10. A box and handle as described in claim 9 in which the strap is metal.

11. A box and handle as described in claim 9 in which the grip member is plastic or rubber.

12. A box and handle as described in claim 9 in which the strap is metal and the grip member is plastic or rubber.

13. A handle comprising:
a substantially flat strap, with an elongated opening, or slot, in each end,
a grip member having a channel therein surrounding the middle part of the strap, and attached thereto.

14. A handle as described in claim 13 in which the strap is metal.

15. A handle as described in claim 13 in which the grip member is plastic or rubber.

16. A handle as described in claim 13 in which the strap is metal and the grip member is plastic or rubber.

17. A box and handle comprising:
a box;
a handle, said handle having a substantially flat strap, with a first elongated opening, or slot, in one end and a second elongated opening, or slot, in the other end,
a grip member having a channel therein surrounding the middle part of the strap, and attached thereto;
a first end piece having a top, a pair of depending sides, and an opening in the top, the first end piece being located on the box, over one end of the strap, with the end of the strap between the depending sides, and the opening in the first end piece aligned with the first elongated opening, or slot, in the strap;
a first fastener extending through the opening in the first end piece, the first elongated opening, or slot, in the strap, and into, or through, the box;
a second end piece having a top, a pair of depending sides, and an opening in the top, the second end piece being located on the box, over the other end of the strap, with the end of the strap between the depending sides, and the opening in the second end piece aligned with the second elongated opening, or slot, in the strap; and
a second fastener extending through the opening in the second end piece, the second elongated opening, or slot, in the strap, and into, or through, the box.

18. A box and handle as described in claim 17 in which the strap is metal.

19. A box and handle as described in claim 17 in which the grip member is plastic or rubber.

20. A box and handle as described in claim 17 in which the strap is metal and the grip member is plastic or rubber.

21. A box and handle comprising:
a box;
a handle, said handle having a substantially flat strap, with a first elongated opening, or slot, in one end and a second elongated opening, or slot, in the other end,
a grip member having a channel therein surrounding the middle part of the strap, and attached hereto;
a first end piece having a top, a pair of depending sides, and an opening in the top, the first end piece being located on the box, over one end of the strap, with the end of the strap between the depending sides, and the opening in the first end piece aligned with the first elongated opening, or slot, in the strap;
a first fastener extending through the opening in the first end piece, the first elongated opening, or slot, in the strap, and into, or through, the box;
a second end piece having a top, a pair of depending sides, and an opening in the top, the second end piece being located on the box, over the other end of the strap, with the end of the strap between the depending sides, and the opening in the second end piece aligned with the second elongated opening, or slot, in the strap; and
a second fastener extending through the opening in the second end piece, the second elongated opening, or slot, in the strap, and into, or through, the box.
a first cap, having a pair of depending sides, located over the first end piece, with the depending sides of the first cap engaging the depending sides of the first end piece; and
a second cap having a pair of depending sides, located over the second end piece, with the depending sides of the second cap engaging the depending sides of the second end piece.

22. A box and strap as described in claim 21 in which the strap is metal.

23. A box and strap as described in claim 21 in which the grip member is plastic or rubber.

24. A box and strap as described in claim 21 in which the strap is metal and the grip member is plastic or rubber.
